(19) United States
(12) Patent Application Publication
(10) Pub. No.: US 2010/0070951 A1
(43) Pub. Date: Mar. 18, 2010

(54) GENERIC ASSEMBLER

(75) Inventor: Yinon Yamin, Rehovot (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: Horizon Semiconductors Ltd., Herzliya (IL)

(21) Appl. No.: 12/210,322

(22) Filed: Sep. 15, 2008

(51) Int. Cl. G06F 9/44

(52) U.S. Cl. 717/136

(57) ABSTRACT

The present invention relates to a method for realizing a generic assembler capable of translating a source code into machine codes for various processor-architectures comprising the steps of: (a) providing an assembler capable of reading a definitions file for translating source code commands into machine code commands; (b) loading said definitions file, which holds definitions related to a processor-architecture, into said assembler; (c) parsing and assessing, by said assembler, said definitions file for finding errors; (d) preparing the internal data structures of said assembler based on said definitions of said definitions file; and (e) translating a source code into a machine code, by said assembler, using said definitions from said definitions file.

### FIELD OF THE INVENTION

The present invention relates to the field of machine code assemblers. More particularly, the invention relates to a method for using the same assembly language and the same assembler for programming machine codes for various processors.

### BACKGROUND OF THE INVENTION

Assembly language is used primarily for direct hardware manipulation, access to specialized processor instructions, or to address critical performance issues. Typical uses are for device drivers, low-level embedded systems, and real-time systems. Programming in assembly language provides the programmer much control over the hardware performance of the system.

A group of statements written in an assembly language is referred to as a source code. Before the source code can be executed, the source statements of the source code must be transformed to machine readable/executable code. In order to generate a machine code from a source code, an assembler is required. The assembler includes a parser for reading the source code and a code generator for generating the machine readable/executable code. Thus, the assembler translates the source code into an object code, which consists of machine readable code, data, and address constants.

Each processor-architecture has its own machine code presentation. On this level, each instruction is simple enough to be executed using a relatively small number of electronic circuits. Processors differ by the number and type of operations they support. For example, a 64-bit machine would have different circuitry from a 32-bit machine, and thus require a different set of machine code operations. Different processors may also have different sizes and numbers of registers and different representations of data types in storage. While most general-purpose processors are able to carry out essentially the same functionality, the ways they do so differ; the corresponding machine code reflect these differences.

As of today many assembly languages use related syntax and grammar for programming. However, once the source code is written in an assembly language, the source code is typically translated by an assembler designed for a specific type of processor-architecture. Since typically a processor requires a specific representation of its machine code, only an assembler designed to generate that representation may be used. Thus different assemblers are required for different processor-architectures.

US 2002/0078324 discloses a microprocessor for processing various assembler codes. The disclosed microprocessor computes relative addresses of different program counter definitions. The relative addressing is dependent on the operating state or parameter of the respective assembler code. Nevertheless, the disclosed microprocessor only deals with relative addressing for different machine codes, it does not deal with different commands, symbols or data representations.

U.S. Pat. No. 7,111,287 discloses an assembler and an assembly language code that includes a plurality of code blocks associated with resource needs. The disclosed method allows the global assignment of resource needs to resources in order that run time resource conflicts are avoided. A grammar is also disclosed for allowing the definition of resource needs. Nevertheless, the described method requires the learning of a new grammar and a new assembly language in order assign resources efficiently.

It is an object of the present invention to provide an assembler capable of generating different machine codes for different processor-architectures.

It is another object of the present invention to provide a method for translating and assembling a generic source code into different machine codes.

It is still another object of the present invention to provide an assembler which does not require the programmer to learn a new assembly language or new grammar in order to program a new type of processor-architecture.

It is still another object of the present invention to provide a method that allows reusability of source code, programmed for one processor-architecture, for another processor-architecture.

Other objects and advantages of the invention will become apparent as the description proceeds.

### SUMMARY OF THE INVENTION

The present invention relates to a method for realizing a generic assembler capable of translating a source code into machine codes for various processor-architectures comprising the steps of: (a) providing an assembler capable of reading a definitions file for translating source code commands into machine code commands; (b) loading said definitions file, which holds definitions related to a processor-architecture, into said assembler; (c) parsing and assessing, by said assembler, said definitions file for finding errors; (d) preparing the internal data structures of said assembler based on said definitions of said definitions file; and (e) translating a source code into a machine code, by said assembler using said definitions from said definitions file.

Preferably, the machine code is intended for a microprocessor.

Preferably, the definitions file defines register amounts and names.

Preferably, the definitions file defines the pipeline depth.

Preferably, the definitions file defines opcode sizes.

In one of the embodiments, the errors are found from definition conflicts in the definitions file.

### BRIEF DESCRIPTION OF THE DRAWINGS

In the drawings:

FIG. 1 is a block diagram depicting the operation of a conventional prior art assembler.

FIG. 2 is a block diagram depicting the operation of a generic assembler according to an embodiment of the invention.

### DETAILED DESCRIPTION OF PREFERRED EMBODIMENTS

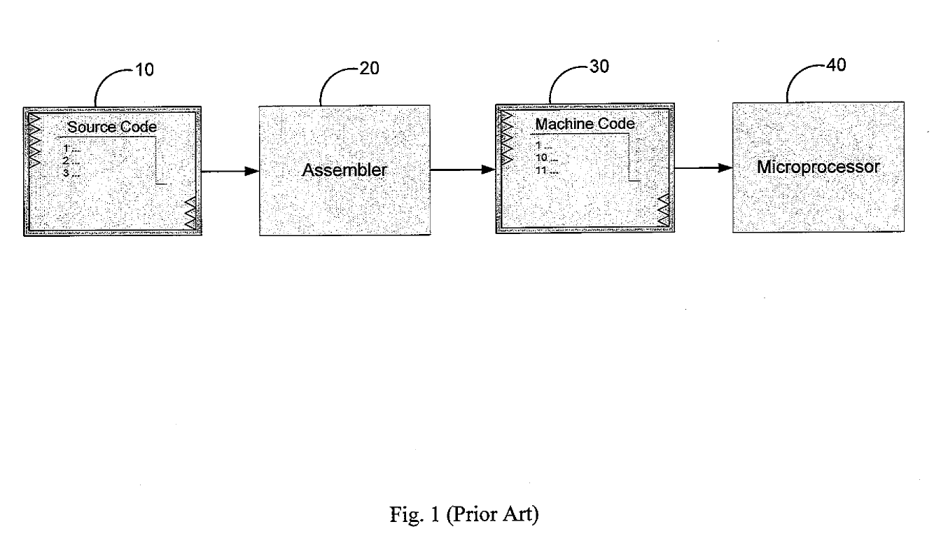

FIG. 1 is a block diagram depicting the operation of a conventional prior art assembler. The source code 10 comprises commands written in assembly language. The source code 10 is fed to the prior art assembler 20 which translates and assembles the source code 10 to a specific machine code 30. The machine code 30, which is typically in binary form, is then loaded into microprocessor 40. In order to acquire the correct machine code representation 30 for microprocessor 40, a corresponding assembler must be chosen which can generate the machine code 30 according to the microprocessor's 40 architecture. Thus once the correct assembler 20 is chosen it can translate the source code 10 into machine code 30, which is specifically tailored for the architecture of microprocessor 40.

The heart of the invention lies in the use of a generic assembler capable of translating assembly commands to machine code based on a definitions file. By generic assembler it is meant to include an assembler that can parse commands used for known assemblers such as GAS for i64, and translate those commands into a specific machine code, intended for a specific processor-architecture, based on definitions from a definitions file. The definitions file may store addresses, sizes, symbols, register amounts and names, pipeline depth, opcode sizes memory definitions and address spaces etc. of a certain processor architecture. The definitions file may also define certain commands of the assembly language such as: RISC commands (for instance: addsub a command for adding or subtracting according to a given parameter), auxiliary commands (like: add for defining the parameters of addsub) and Label based commands (branch and load/store). Thus the same generic assembler may be used for generating different machine codes for different processor architectures based on different definitions from different definitions files. Each time a programmer wishes to translate a source code for a processor, he may load the intended processor's architectures definitions file into the generic assembler, and use the generic assembler for translating the source code to the processor's machine code. Once the definitions file is loaded into the assembler, the assembler translates the source code into a machine code according to the definitions in the definitions file.

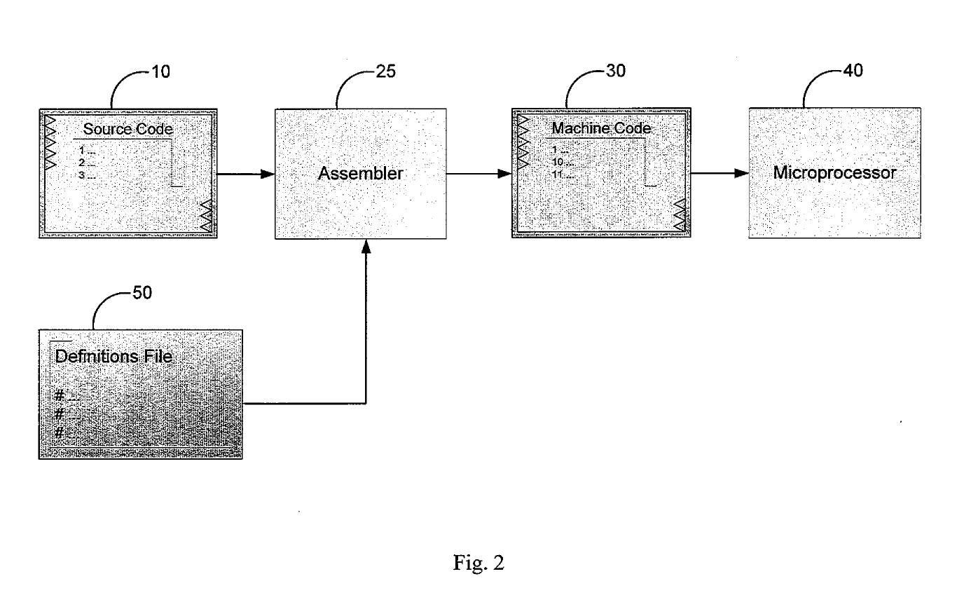

FIG. 2 is a block diagram depicting the operation of a generic assembler according to an embodiment of the invention. At first a definitions file 50 is selected which corresponds to the processor architecture of microprocessor 40. The definitions file 50 corresponds with the architecture of the microprocessor 40. Thus when both files, source code 10 and definitions file 50, are loaded into generic assembler 25, generic assembler 25 translates and assembles source code 10 according to the information in definition file 50. After source code 10 is translated and assembled into machine code 30 by generic assembler 25 it may be loaded into microprocessor 40. As stated above, the machine code 30 is specifically tailored to the architecture of microprocessor 40 since it has been translated according to definition file 50.

For the sake of brevity an example is set forth for demonstrating the operation of the generic assembler. The described generic assembler can translate an assembly command from a source code to a machine code command using a definitions file. In this example the definition file, defines that there are only 2 available registers, in this processor-architecture, which their names are register1 and register2. The definitions file also defines that register1 and register2 are assigned the codes 0×1 and 0×2 respectively. Continuing the example, a source code command, written in assembly language, is shown:
add register1, 5, register2
   which means that the value stored in register1 should be added with 5 and stored in register2. Therefore when translated to machine code, the add command may be translated to 0×42, the register1 to 0×1, the 5 to 0×0005, and register2 to 0×2. Thus the translated command opcode may be 0×42100052. The same source code command may be translated differently if the definitions file would have given different addresses to register1 and register2. In another example, if the source code command would have called for register3 the assembler would have reported an error message stating that there register3 does not exist in this architecture.

In one of the uses of the invention, the engineer who designs the hardware of the processor is the one who creates the definitions file. Thus after the designing engineer defined his designed hardware in the definitions file and provided the definitions file, any assembly programmer can program for the processor without investing extra time in learning all the hardware setup.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for realizing a generic assembler capable of translating a source code into machine codes for various processor-architectures comprising the steps of:
a. providing an assembler capable of reading a definitions file for translating source code commands into machine code commands;
b. loading said definitions file, which holds definitions related to a processor-architecture, into said assembler;
c. parsing and assessing, by said assembler, said definitions file for finding errors;
d. preparing the internal data structures of said assembler based on said definitions of said definitions file; and
e. translating a source code into a machine code, by said assembler, using said definitions from said definitions file.

2. A method according to claim 1, where the machine code is intended for a microprocessor.

3. A method according to claim 1, where the definitions file defines register amounts and names.

4. A method according to claim 1, where the definitions file defines the pipeline depth.

5. A method according to claim 1, where the definitions file defines opcode sizes.

6. A method according to claim 1, where the errors are found from definition conflicts in the definitions file.
